(19) United States
(12) Patent Application Publication
(10) Pub. No.: US 2009/0020500 A1
(43) Pub. Date: Jan. 22, 2009

(54) METHOD OF FORMING PASSAGE THROUGH SUBSTRATE FOR MEMS MODULE

(75) Inventors: Chiung-Yueh TIEN, Taichung County (TW); Hsi-Chen Yang, Taichung County (TW)

Correspondence Address: BROWDY AND NEIMARK, P.L.L.C.;624 NINTH STREET, NW, SUITE 300, WASHINGTON, DC, 20001-5303, US

(73) Assignee: Lingsen Precision Industries, LTD., Taichung (TW)

(21) Appl. No.: 11/936,318

(22) Filed: Nov. 7, 2007

(30) Foreign Application Priority Data
Jul. 18, 2007 (TW) 96126252

(51) Int. Cl. H01B 13/00

(52) U.S. Cl. 216/13

(57) ABSTRACT

A method of forming a passage through a substrate for a MEMS module is disclosed to include the steps of: a) etching a substrate having a thickness smaller than 0.30 mm to form a bottom recess; b) etching a top side of the substrate to form a top recess to define a part of the substrate as a sacrifice portion; c) forming a bottom layer in the bottom recess of the substrate by injection molding; d) depositing a support layer in the top recess of the substrate; and e) removing the sacrifice portion from the substrate by etching to form a passage defined between the support layer and the bottom layer in the substrate with two ends in communication with ambient atmosphere.

### BACKGROUND OF THE INVENTION

1. Field of the Invention

The present invention relates generally to Micro-Electro-Mechanical System (hereinafter referred to as “MEMS”) modules and more specifically, to a method of forming a passage through a substrate for use in a MEMS module.

2. Description of the Related Art

In order to improve the performance of a MEMS module, the mechanical support strength and other environmental factors, such as interference of noises, must be taken into account during packaging of the MEMS module. Some MEMS devices have a particular structure. For example, a microphone receives an external signal from the bottom side. In this case, the substrate must provide a curved sensor passage in communication with the bottom side of the MEMS chip so that the MEMS chip can receive an external signal from the bottom side.

However, it is difficult to form a nonlinear sensor passage in a substrate directly. According to conventional methods, the formation of the nonlinear sensor passage is done by means of stacking multiple plate members together. A plate member for this purpose has at least 0.18 mm usually. Forming a nonlinear sensor passage requires at least two plate members, i.e., a stack substrate structure will have a height at least 0.36 mm, which occupies a lot of space. Further, a stack substrate structure that is made by means of stacking multiple plate members together may encounter a peeling problem between two plate members.

Therefore, it is desirable to provide a method of forming a passage in a substrate for a MEMS module that eliminates the aforesaid drawbacks.

### SUMMARY OF THE INVENTION

The present invention has been accomplished in view of the above-noted circumstances. It is one objective of the present invention to provide a substrate passage formation method for forming a passage through a substrate for a MEMS (Micro-Electro-Mechanical System) module, which has the characteristic of lowering the height of the substrate for use in a low profile MEMS module.

To achieve the above-mentioned objective of the present invention, the method of forming a passage through a substrate for a MEMS module provided by a first exemplary embodiment to be detailedly described hereinafter comprises the steps of: a) etching a substrate having a thickness smaller than 0.30 mm to form a bottom recess; b) etching a top side of the substrate to form a top recess to define a part of the substrate as a sacrifice portion; c) forming a bottom layer in the bottom recess of the substrate by injection molding; d) depositing a support layer in the top recess of the substrate; and e) removing the sacrifice portion from the substrate by etching to form a passage defined between the support layer and the bottom layer in the substrate with two ends in communication with ambient atmosphere.

The method of forming a passage through a substrate for a MEMS module provided by a second exemplary embodiment to be detailedly described hereinafter comprises the steps of: a) etching a substrate having a thickness smaller than 0.30 mm to form a top recess having a first portion disposed at a top side of the substrate and a second portion penetrating the substrate and communicating with the first portion; b) placing a sacrifice member in the first portion of the top recess of the substrate; c) depositing a support layer on the top side of the substrate to partially cover the sacrifice member; and d) removing the sacrifice member by etching such that the space left by removal of the sacrifice member and the second portion of the top recess form a passage surrounded by the support layer and the substrate with two ends in communication with ambient atmosphere.

The invention employs etching and deposit techniques to form a passage through a substrate. Therefore, the invention allows the use of one single piece substrate to substitute for a conventional stack substrate structure. The spirit of the invention is to form a predetermined path step by step by means of etching, and to form a support layer step by step by means of deposit. When compared with the prior art design, the invention can lower the height of the substrate.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a schematic drawing of a step of the method provided according to a first embodiment of the present invention, showing a substrate prepared before processing;

FIG. 2 is a schematic drawing showing the processing of the bottom side of the substrate;

FIG. 3 is a schematic drawing showing the processing of the top side of the substrate;

FIG. 4 is a schematic drawing showing that a bottom layer is formed;

FIG. 5 is a schematic drawing showing that a support layer is formed;

FIG. 6 is a schematic drawing showing formation of a passage through the substrate;

FIG. 7 is a schematic drawing showing an application example of the first embodiment of the present invention in a MEMS module;

FIG. 8 is a schematic drawing of a step of the method provided according to a second embodiment of the present invention, showing a substrate prepared before processing;

FIG. 9 is a schematic drawing showing that the top side of the substrate is processed;

FIG. 10 is a schematic drawing showing that the bottom side of the substrate is processed;

FIG. 11 is a schematic drawing showing that a sacrifice portion is formed;

FIG. 12 is a schematic drawing showing that a support layer is formed, and

FIG. 13 is a schematic drawing showing formation of a passage through the substrate.

### DETAILED DESCRIPTION OF THE INVENTION

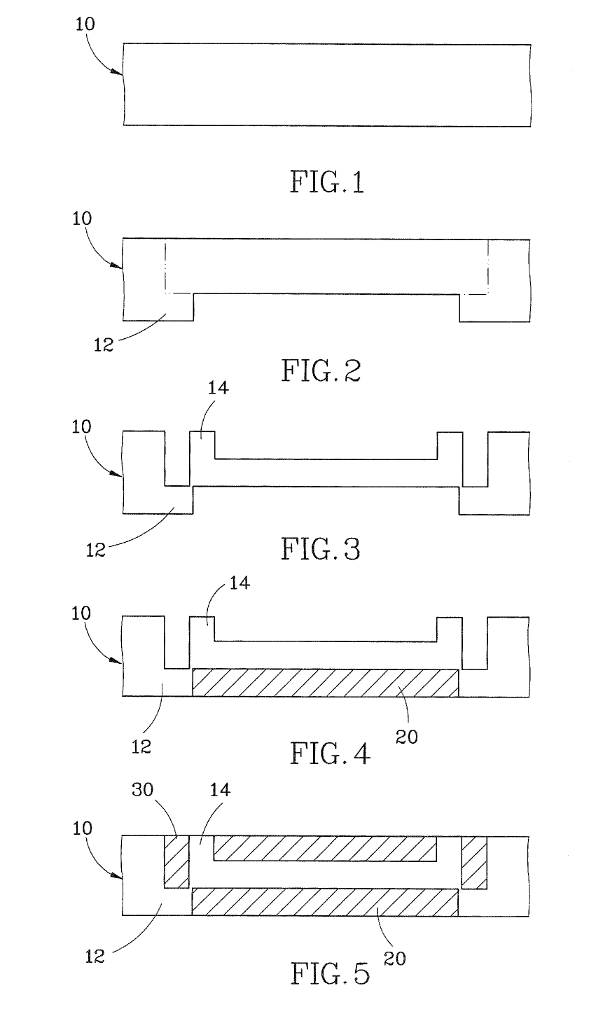

As shown in FIGS. 1-6, a substrate passage formation method for forming a passage through a substrate for a MEMS module in accordance with a first embodiment of the present invention includes the following steps.

a) Prepare a substrate 10 having a thickness smaller than 0.30 mm or preferably 0.25 mm, as shown in FIG. 1. The substrate 10 can be made by glass fiber-contained resin, epoxy, polyimide resin, FR4 resin, and BT (bismaleimide-triazine) resin. And then, etch the bottom side of the substrate 10 to form a bottom recess in the bottom side of the substrate 10 so as to define a part of the substrate 10 as a non-sacrifice layer 12, as shown in FIG. 2. Because the non-sacrifice layer 12 has formed integral with the other part of the substrate 10 and the connection area between the non-sacrifice portion 12 and the other part of the substrate 10 is not easily recognizable, an imaginary line is used to identify the non-sacrifice portion 12.

b) Etch the top side of the substrate 10 to form a top recess of predetermined profile in the top side of the substrate 10 so as to define a part of the substrate as a sacrifice portion 14 having a predetermined profile of the desired passage, as shown in FIG. 3, between the top recess and the bottom recess.

c) Fill up the bottom recess surrounded by the non-sacrifice portion 12 and the sacrifice portion 14 with a thermal setting resin by means of injection molding to form a bottom layer 20 having an anti-etching coefficient greater than the sacrifice portion 14 of the substrate 10. The bottom surface of the bottom layer 20 is kept in flush with the bottom surface of the substrate 10, as shown in FIG. 4.

d) Deposit a support layer 30 having an anti-etching coefficient greater than the sacrifice portion 14 of the substrate 10 in the top recess of the substrate 10, as shown in FIG. 5.

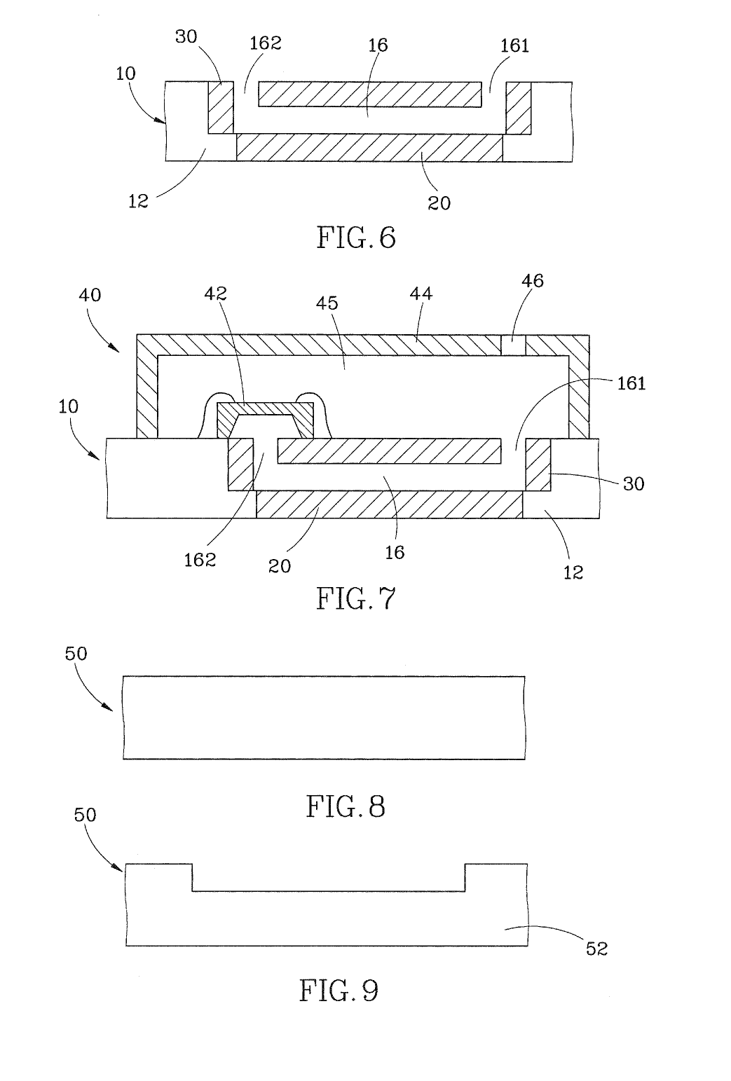

e) Remove the sacrifice portion 14 from the substrate 10 so as to form a passage 16 in the substrate 10, as shown in FIG. 6.

Because the bottom layer 20 and the support layer 30 have an anti-etching coefficient greater than the sacrifice portion 14 of the substrate 10, the bottom layer 20 and the support layer 30 are kept intact when etching the substrate 10 to remove the sacrifice portion 14. After removal of the sacrifice portion 14, the bottom layer 20, the non-sacrifice portion 12 and the support layer 30 define a passage 16 having two distal ends disposed in communication with ambient atmosphere, as shown in FIG. 6. The passage 16 has an inlet 161 and an outlet 162 respectively disposed at the same side of the substrate 10. According to this first embodiment, the inlet 161 and the outlet 162 are disposed at the top side of the substrate 10, and kept apart in horizontal direction.

According to the aforesaid procedure, this first embodiment employs etching and deposit techniques to form a passage through a substrate. Therefore, the invention allows the use of one single piece substrate to substitute for a conventional stack substrate structure. The spirit of the invention is to form a predetermined path step by step by means of etching, and to form the said support layer 30 by deposit, thereby achieving formation of the desired passage through the substrate 10. When compared with the prior art design, the invention can reduce the height of the substrate 10 to 0.36 mm or smaller, lowering the profile of the MEMS module.

FIG. 7 illustrates an application of a substrate 10 having the said passage 16 in a MEMS module 40. As illustrated, the MEMS module 40 comprises a substrate 10, a MEMS device 42, and a metal cap 44. The MEMS device 42 is installed in the top side of the substrate 10 to block the outlet 162. The metal cap 44 is capped on the top side of the substrate 10, defining with the top side of the substrate 10 an accommodation chamber 45 that accommodates the MEMS device 42. The metal cap 44 has a through hole 46 in air communication between the inlet 161 of the substrate 10 and the atmosphere. Thus, an external physical signal can go through the through hole 46 of the metal cap 44 to the MEMS device 42 via the passage 16, and therefore receiving of an external signal is achieved.

FIGS. 8-13 show the steps of a substrate passage formation method for forming a passage through a substrate for MEMS module in accordance with a second embodiment of the present invention as follows.

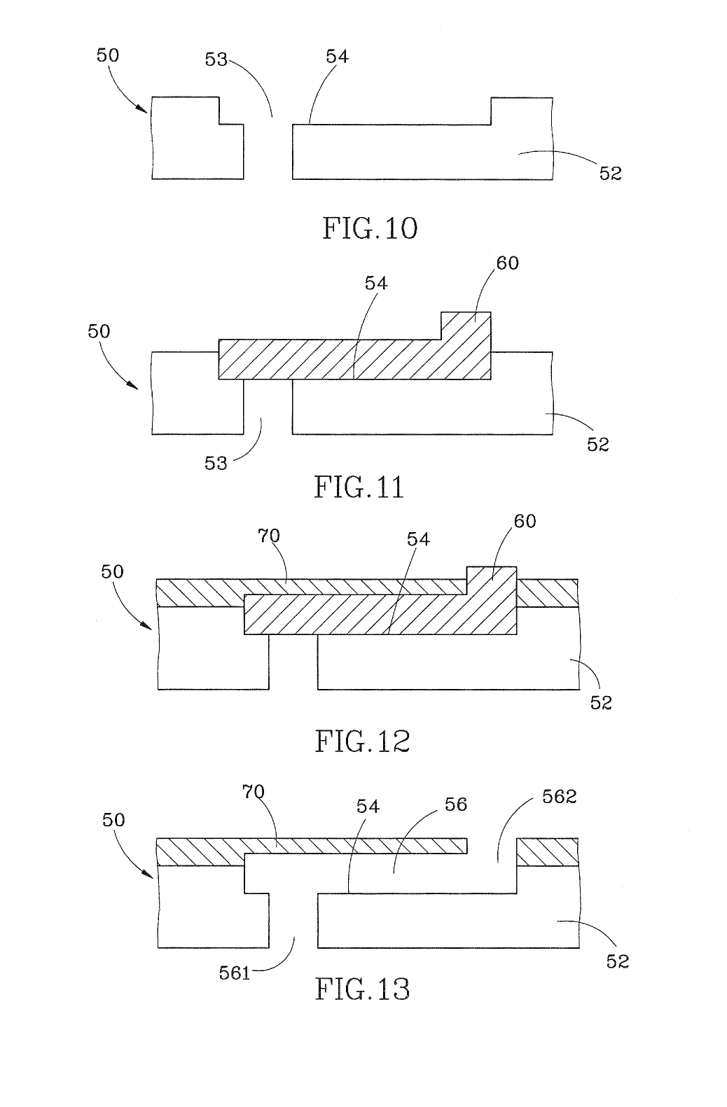

a) Prepare a substrate 50 having a thickness below 0.30 mm or preferably 0.25 mm, as shown in FIG. 8. The substrate 50 can be made by glass fiber-contained resin, epoxy, polyimide resin, FR4 resin, and BT (bismaleimide-triazine) resin. And then, etch the top side of the substrate 50 to form a top recess 53, as shown in FIG. 10, to define the remainder of the substrate 10 as a non-sacrifice portion 52. As shown in FIG. 10, the top recess 53 has a first portion horizontally disposed at the top side of the substrate 10 and a second portion vertically penetrating the substrate 10 and communicating with the first portion, such that the non-sacrifice portion 52 is provided with a step 54 at the conjunction of the first and second portions of the top recess 53.

b) Provide the substrate 50 with a sacrifice member 60 having a predetermined pattern for the desired passage to have the bottom of the sacrifice member 60 rested on the step 54, i.e. the sacrifice member 60 is fitted into the first portion of the space 53. The sacrifice member 60 has an anti-etching coefficient smaller than the substrate 50. As shown in FIG. 11, the sacrifice member 60 has a base having a thickness greater than the depth of the first portion of the top recess 53 fitted in the first portion of the top recess 53, and a protrusion uprightly extending from the top side of an end of the base.

c) Deposit a support layer 70 having an anti-etching coefficient greater than the sacrifice member 60 on the top side of the substrate 50 to partially cover the sacrifice member 60, i.e. to cover the base of the sacrifice member 60 and to have the protrusion of the sacrifice member 60 extend out of the support layer 70, as shown in FIG. 12.

d) Remove the sacrifice member 60 by etching as shown in FIG. 13 such that a passage 56. is formed by combination of the second portion of the top recess and the space left by removal of the sacrifice member 60.

Because the substrate 50 and the support layer 70 have an anti-etching coefficient greater than the sacrifice member 60, the substrate 50 and the support layer 70 are kept intact when removing the sacrifice member 60 by etching. After removal of the sacrifice member 60, the non-sacrifice portion 52 and the support layer 70 define therebetween a passage 56 having two distal ends in communication with the atmosphere. The passage 56 has an inlet 561 and an outlet 562. The inlet 561 is disposed at the bottom side of the substrate 50 and the outlet 562 is disposed at the top side of the substrate 40. Further, the inlet 561 and the outlet 562 are kept apart in horizontal direction.

Similar to the aforesaid first embodiment, this second embodiment employs etching and deposit techniques, allowing the use of one single piece of substrate to substitute for a stack substrate structure. The difference between this second embodiment and the aforesaid first embodiment is that a sacrifice member 60 is sued in the second embodiment to substitute for the sacrifice portion in the first embodiment. Therefore, this second embodiment achieves the same effects as the aforesaid first embodiment.

In conclusion, the present invention employs etching and deposit techniques to form a passage through a substrate. Therefore, the invention allows the use of one single piece substrate to substitute for a conventional stack substrate structure. The spirit of the invention is to make a predetermined path step by step by means of etching the bottom side of the substrate, and to form the support layer on the top side of the substrate step by step by means of deposit, thereby achieving formation of the desired passage through the substrate. When compared with the prior art design, the invention effectively reduces the height of the substrate, practical for the fabrication of a low profile MEMS module.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of forming a passage through a substrate for a MEMS module, comprising the steps of:
a) etching a substrate having a thickness smaller than 0.30 mm to form a bottom recess at a bottom side of the substrate;
b) etching a top side of the substrate to form a top recess to define a part of the substrate as a sacrifice portion between the top recess and the bottom recess;
c) forming a bottom layer in the bottom recess of the substrate by injection molding;
d) depositing a support layer in the top recess of the substrate; and
e) removing the sacrifice portion from the substrate by etching to form a passage defined between the support layer and the bottom layer in the substrate with two ends in communication with ambient atmosphere.

2. The method of claim 1, wherein the substrate is made form a material selected form the group consisting of glass fiber-contained resin, epoxy, polyimide resin, FR4 resin, and bismaleimide-triazine resin.

3. The method of claim 1, wherein the bottom layer is formed by a thermal setting resin having an anti-etching coefficient greater than the substrate.

4. The method of claim 1, wherein the support layer has an anti-etching coefficient greater than the substrate.

5. A method of forming a passage through a substrate for a MEMS module, comprising the steps of:
a) etching a substrate having a thickness smaller than 0.30 mm to form a top recess having a first portion disposed at a top side of the substrate and a second portion penetrating the substrate and communicating with the first portion;
b) placing a sacrifice member in the first portion of the top recess of the substrate;
c) depositing a support layer on the top side of the substrate to partially cover the sacrifice member; and
d) removing the sacrifice member by etching such that the space left by removal of the sacrifice member and the second portion of the top recess form a passage surrounded by the support layer and the substrate with two ends in communication with ambient atmosphere.

6. The method of claim 5, wherein the substrate is made form a material selected form the group consisting of glass fiber-contained resin, epoxy, polyimide resin, FR4 resin, and bismaleimide-triazine resin.

7. The method of claim 5, wherein the sacrifice member has an anti-etching coefficient smaller than the substrate.

8. The method of claim 5, wherein the support layer has an anti-etching coefficient greater than the sacrifice member.
